(19) United States
(12) Patent Application Publication
(10) Pub. No.: US 2018/0373818 A1
(43) Pub. Date: Dec. 27, 2018

(54) SYSTEMS AND METHODS FOR RECONFIGURATION OF ELECTRICAL ARCHITECTURE FOR AUTOMOTIVE DESIGN OPTIONS

(71) Applicant: GM GLOBAL TECHNOLOGY OPERATIONS LLC, Detroit, MI (US)

(72) Inventors: GAETANO G. BUFFA, II, FLINT, MI (US); JUSTIN LOUDERMILK, FLINT, MI (US); JAMES MIDTUN, CHANDLER, AZ (US)

(73) Assignee: GM GLOBAL TECHNOLOGY OPERATIONS LLC, Detroit, MI (US)

(21) Appl. No.: 15/630,649

(22) Filed: Jun. 22, 2017

(51) Int. Cl. G06F 17/50

(52) U.S. Cl. CPC G06F 17/5004; G06F 17/5095; G06F 17/5022

(57) ABSTRACT

A method for reconfiguring an electrical architecture for a vehicle is provided. The method obtains global design data comprising automotive options applicable to a set of vehicles, by a processor, wherein the set of vehicles comprises the vehicle; translates the automotive options of the global design data into terms applicable to a vehicle platform, to create a mapping file; obtains a design project applicable to the vehicle platform, wherein the design project comprises at least a plurality of expressions associated with the automotive options and a vehicle platform diagram, and wherein the plurality of expressions comprise at least one of mathematical expressions and logical expressions; generates an mapped set of designs for the design project, using the terms applicable to the vehicle platform; and creates electrical build configurations for the vehicle platform, based on the mapped set of designs, wherein the electrical build configurations comprise a revised vehicle platform design.

### TECHNICAL FIELD

Embodiments of the subject matter described herein relate generally to reconfiguration of automotive electrical architecture. More particularly, embodiments of the subject matter relate to mapping global design options to vehicle platform-specific options, and performing an advanced reconfiguration of the automotive electrical architecture based on the mapping.

### BACKGROUND

Automotive design includes hardware and software design of vehicle electrical configuration. Designs may be applicable to all vehicles, a set of vehicles, and subsets of the set of vehicles. More specifically, automotive designs may include “global” generic optioning that is applicable to a broad range of makes, models, and other vehicle variations. Consequently, typical designs may include reference to vehicle options that are not applicable to particular vehicle platforms. In many cases, changes to the vehicle hardware and software design, including changes to the vehicle options, may require repetitive manual input of information.

Accordingly, it is desirable to reduce the amount of manual data entry for changes to vehicle design, and thus the time required to perform such data entry. Furthermore, other desirable features and characteristics will become apparent from the subsequent detailed description and the appended claims, taken in conjunction with the accompanying drawings and the foregoing technical field and background.

### BRIEF SUMMARY

Some embodiments of the present disclosure provide a method for reconfiguring an electrical architecture for a vehicle. The method obtains global design data comprising automotive options applicable to a set of vehicles, by a processor, wherein the set of vehicles comprises the vehicle; translates the automotive options of the global design data into terms applicable to a vehicle platform, to create a mapping file; obtains a design project applicable to the vehicle platform, wherein the design project comprises at least a plurality of expressions associated with the automotive options and a vehicle platform diagram, and wherein the plurality of expressions comprise at least one of mathematical expressions and logical expressions; generates an mapped set of designs for the design project, using the terms applicable to the vehicle platform; and creates electrical build configurations for the vehicle platform, based on the mapped set of designs, wherein the electrical build configurations comprise a revised vehicle platform design.

Some embodiments of the present disclosure provide a system for reconfiguring an electrical architecture for a vehicle. The system includes a memory element, configured to store vehicle platform data and global design data comprising automotive options applicable to a set of vehicles; and at least one processor, communicatively coupled to the memory element, wherein the at least one processor is configured to: obtain global design data comprising automotive options applicable to the set of vehicles, wherein the set of vehicles comprises the vehicle; translate the automotive options of the global design data into terms applicable to a vehicle platform, to create a mapping file; obtain a design project applicable to the vehicle platform, wherein the design project comprises at least a plurality of expressions associated with the automotive options and a vehicle platform diagram, and wherein the plurality of expressions comprise at least one of mathematical expressions and logical expressions; generate a mapped set of designs for the design project, using the terms applicable to the vehicle platform; and create electrical build configurations for the vehicle platform, based on the mapped set of designs, wherein the electrical build configurations comprise a revised vehicle platform design.

Some embodiments of the present disclosure provide a non-transitory, computer-readable medium containing instructions thereon, which, when executed by a processor, perform a method. The method obtains global design data comprising automotive options applicable to a set of vehicles, by the processor; translates the automotive options of the global design data into terms applicable to a vehicle platform, to create a mapping file; obtains a design project applicable to the vehicle platform, wherein the design project comprises at least a plurality of expressions associated with the automotive options and a vehicle platform diagram, and wherein the plurality of expressions comprise at least one of mathematical expressions and logical expressions; generates a mapped set of designs for the design project, using the terms applicable to the particular vehicle platform, by: identifying a subset of the plurality of expressions of the design project, wherein the subset includes one of the automotive options; finding instances of the one of the automotive options in the subset; and replacing the instances of the one of the automotive options with one of the terms applicable to the vehicle platform. The method then creates electrical build configurations for the vehicle platform, based on the mapped set of designs, wherein the electrical build configurations comprise a revised vehicle platform design; and generates an electrical wiring architecture for the vehicle platform, based on the electrical build configurations.

This summary is provided to introduce a selection of concepts in a simplified form that are further described below in the detailed description. This summary is not intended to identify key features or essential features of the claimed subject matter, nor is it intended to be used as an aid in determining the scope of the claimed subject matter.

### BRIEF DESCRIPTION OF THE DRAWINGS

A more complete understanding of the subject matter may be derived by referring to the detailed description and claims when considered in conjunction with the following figures, wherein like reference numbers refer to similar elements throughout the figures.

FIG. 1 is a diagram of a system for reconfiguring the electrical architecture of a vehicle, in accordance with the disclosed embodiments;

FIG. 2 is a functional block diagram of a computer system for use in a system for reconfiguring the electrical architecture of a vehicle, in accordance with the disclosed embodiments;

FIG. 3 is a flow chart that illustrates an embodiment of a process for reconfiguring an electrical architecture for a vehicle, in accordance with the disclosed embodiments;

FIG. 4 is a flow chart that illustrates an embodiment of a process for translating the automotive options, in accordance with the disclosed embodiments;

FIG. 5 is a flow chart that illustrates a second embodiment of a process for translating the automotive options, in accordance with the disclosed embodiments;

FIG. 6 is a flow chart that illustrates a third embodiment of a process for translating the automotive options, in accordance with the disclosed embodiments;

FIG. 7 is a flow chart that illustrates an embodiment of a process for generating a mapped set of designs, in accordance with the disclosed embodiments; and

FIG. 8 is a flow chart that illustrates an embodiment of a process for initiating reconfiguration of an electrical architecture for a vehicle, in accordance with the disclosed embodiments.

### DETAILED DESCRIPTION

The following detailed description is merely illustrative in nature and is not intended to limit the embodiments of the subject matter or the application and uses of such embodiments. As used herein, the word “exemplary” means “serving as an example, instance, or illustration.” Any implementation described herein as exemplary is not necessarily to be construed as preferred or advantageous over other implementations. Furthermore, there is no intention to be bound by any expressed or implied theory presented in the preceding technical field, background, brief summary or the following detailed description.

The subject matter presented herein relates to systems and methods for reconfiguring the electrical architecture of a vehicle using stored, global designs applicable to a broad range of vehicles and modifying these global designs for a particular vehicle platform, in an automated manner. Contemplated herein is the ability to repeatedly “re-map” from global designs to platform designs across the same set of designs such that the original global options are still considered, thus allowing for the incremental mapping or changing of previous mappings without having to adjust the mapping file to have the “mapped to” options become “mapped from” options.

Certain terminologies are used with regard to the various embodiments of the present disclosure. Global design data is a listing or registry of the available features, characteristics, and automotive options for a set of vehicles, a particular design of a vehicle, and/or any applicable set or group of vehicles. A vehicle platform is a subset of the global design data, wherein the vehicle platform includes automotive options, and variations of automotive options, that are specific to a particular vehicle make and/or vehicle model. Automotive options are features, variations, and other details specific to a set of vehicles. For example, automotive options for a vehicle may include side marker lamps or a lack of side marker lamps, wherein the side marker lamps is an automotive option and the lack of side maker lamps is an automotive option. Further, automotive options may include sub-options. For example, the automotive option for side marker lamps may include either incandescent side marker lamps or light emitting diode (LED) side marker lamps, wherein the incandescent side marker lamps are another automotive option and the LED side marker lamps are another automotive option.

A global design project is a software model of the hardware connectivity of the electrical system of set of electrical design solution for various vehicle platforms, which may be used by a developer in a vehicle specific design project to design variations for a particular vehicle platform. The global design project includes mathematical and/or logical expressions associated with the automotive options and hardware connectivity diagrams. A vehicle specific design project contains an appropriate subset of global designs for a specific vehicle platform which integrates with appropriate wiring designs to produce vehicle-specific electrical wiring diagrams for a particular vehicle platform. A vehicle-specific design project is a revised design project, wherein the design project has been edited to incorporate the translated or mapped automotive options stored in the mapping file. Thus, the vehicle-specific design project includes vehicle platform-specific automotive options, and may be used in applications specific to the particular vehicle platform. An electrical build configuration is a logical or mathematical set of design associated with the completed vehicle platform, and includes design expressions that are specific to the vehicle platform. An electrical wiring architecture is a specific wiring configuration for the vehicle platform, and is based on the vehicle platform-specific design expressions of the electrical build configuration.

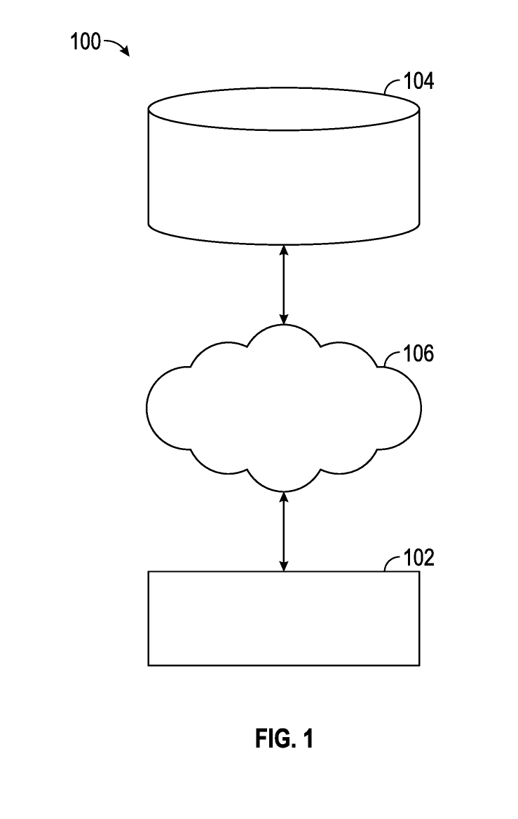

Turning now to the figures, FIG. 1 is a diagram of a system 100 for reconfiguring the electrical architecture of a vehicle, in accordance with the disclosed embodiments. The system 100 operates to reconfigure the electrical architecture of a particular software design project for a vehicle platform. To accomplish this, the system 100 accesses previously created and stored global vehicle designs, modifies the global vehicle designs to create vehicle platform-specific designs such that the global options are mapped to vehicle specific options, and reconfigures the applicable electrical architecture of the design project for the vehicle platform based on the modified global vehicle design. The system 100 may include, without limitation, a computer system 102 that accesses global design data and vehicle platform-specific design data stored in local memory and/or via a remote server system 104. In practice, certain embodiments of the system 100 may include additional or alternative elements and components, as desired for the particular application.

The computer system 102 may be implemented by any computing device that includes at least one processor, some form of memory hardware, a user interface, and communication hardware. For example, the computer system 102 may be implemented using a desktop computer and/or a personal computing device, such as a tablet computer, a laptop computer, a personal digital assistant (PDA), a smartphone, or the like.

The server system 104 may include any number of application servers, and each server may be implemented using any suitable computer. In some embodiments, the server system 104 includes one or more dedicated computers. In some embodiments, the server system 104 includes one or more computers carrying out other functionality in addition to server operations. The server system 104 may store and provide any type of data used to reconfigure the electrical architecture of a vehicle using a software design project. Such data may include, without limitation: global design data, automotive option data, vehicle platform data, and other data compatible with the computer system 102.

The data communication network 106 may be any digital or other communications network capable of transmitting messages or data between devices, systems, or components. In certain embodiments, the data communication network 106 includes a packet switched network that facilitates packet-based data communication, addressing, and data routing. The packet switched network could be, for example, a wide area network, the Internet, or the like. In various embodiments, the data communication network 106 includes any number of public or private data connections, links or network connections supporting any number of communications protocols. The data communication network 106 may include the Internet, for example, or any other network based upon TCP/IP or other conventional protocols. In various embodiments, the data communication network 106 could also incorporate a wireless and/or wired telephone network, such as a cellular communications network for communicating with mobile phones, personal digital assistants, and/or the like. The data communication network 106 may also incorporate any sort of wireless or wired local and/or personal area networks, such as one or more IEEE 802.3, IEEE 802.16, and/or IEEE 802.11 networks, and/or networks that implement a short range (e.g., Bluetooth) protocol. For the sake of brevity, conventional techniques related to data transmission, signaling, network control, and other functional aspects of the systems (and the individual operating components of the systems) may not be described in detail herein.

During typical operation, the computer system 102 obtains relevant data associated with electrical architecture of a vehicle, including global design data for a superset of vehicles that includes the particular vehicle and vehicle platform in question; vehicle platform-specific data, including platform-specific options and variations of options available to the vehicle platform; and mapping or translation data, for configuring the global design data to be applicable to the particular vehicle platform.

The computer system 102 obtains and modifies the global designs, using vehicle platform-specific data (e.g., platform-specific automotive options and variations of options), to create electrical build configurations used to generate vehicle platform-specific electrical wiring diagrams for the vehicle platform. Modification of the global designs includes a high-level, advanced “find-and-replace” operation for the software design project using mapping or translation data associated with the vehicle platform.

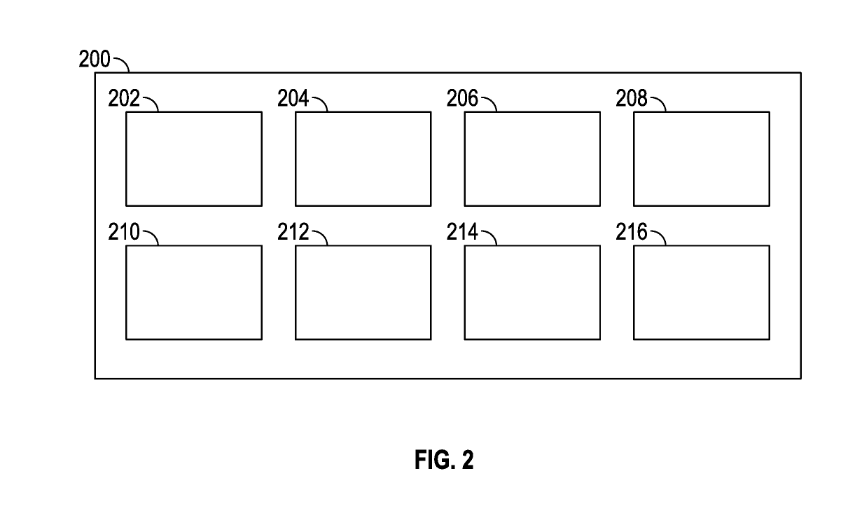

FIG. 2 is a functional block diagram of a computer system 200 for use in a system for reconfiguring the electrical architecture of a vehicle, in accordance with the disclosed embodiments. It should be noted that the computer system 200 can be implemented with the computer system 102 depicted in FIG. 1. In this regard, the computer system 200 shows certain elements and components of the computer system 102 in more detail.

The computer system 200 generally includes, without limitation: at least one processor 202; system memory 204; a user interface 206; a global designs module 208; a vehicle platform module 210; a mapping module 212; an electrical architecture reconfiguration module 214; and a display device 216. These elements and features of the computer system 200 may be operatively associated with one another, coupled to one another, or otherwise configured to cooperate with one another as needed to support the desired functionality—in particular, reconfiguration of the electrical architecture of a particular vehicle or vehicle platform, as described herein. For ease of illustration and clarity, the various physical, electrical, and logical couplings and interconnections for these elements and features are not depicted in FIG. 2. Moreover, it should be appreciated that embodiments of the computer system 200 will include other elements, modules, and features that cooperate to support the desired functionality. For simplicity, FIG. 2 only depicts certain elements that relate to the techniques described in more detail below.

The at least one processor 202 may be implemented or performed with one or more general purpose processors, a content addressable memory, a digital signal processor, an application specific integrated circuit, a field programmable gate array, any suitable programmable logic device, discrete gate or transistor logic, discrete hardware components, or any combination designed to perform the functions described here. In particular, the at least one processor 202 may be realized as one or more microprocessors, controllers, microcontrollers, or state machines. Moreover, the at least one processor 202 may be implemented as a combination of computing devices, e.g., a combination of digital signal processors and microprocessors, a plurality of microprocessors, one or more microprocessors in conjunction with a digital signal processor core, or any other such configuration.

The at least one processor 202 is communicatively coupled to the system memory 204. The system memory 204 is configured to store any obtained or generated data associated with global vehicle designs, vehicle platform-specific designs and options, and graphical elements associated with the reconfiguration of the electrical architecture of a vehicle platform. The system memory 204 may be realized using any number of devices, components, or modules, as appropriate to the embodiment. Moreover, the computer system 200 could include system memory 204 integrated therein and/or a system memory 204 operatively coupled thereto, as appropriate to the particular embodiment. In practice, the system memory 204 could be realized as RAM memory, flash memory, EPROM memory, EEPROM memory, registers, a hard disk, a removable disk, or any other form of storage medium known in the art. In certain embodiments, the system memory 204 includes a hard disk, which may also be used to support functions of the computer system 200. The system memory 204 can be coupled to the at least one processor 202 such that the at least one processor 202 can read information from, and write information to, the system memory 204. In the alternative, the system memory 204 may be integral to the at least one processor 202. As an example, the at least one processor 202 and the system memory 204 may reside in a suitably designed application-specific integrated circuit (ASIC).

The user interface 206 may include or cooperate with various features to allow a user to interact with the computer system 200. Accordingly, the user interface 206 may include various human-to-machine interfaces, e.g., a keypad, keys, a keyboard, buttons, switches, knobs, a touchpad, a joystick, a pointing device, a virtual writing tablet, a touch screen, a microphone, or any device, component, or function that enables the user to select options, input information, or otherwise control the operation of the computer system 200. For example, the user interface 206 could be manipulated by an operator to select a particular mapping file or other option (e.g., build list, current design, latest revision) for use in generating an option expression report, which is later used in generating electrical build configurations for the vehicle platform.

In certain embodiments, the user interface 206 may include or cooperate with various features to allow a user to interact with the computer system 200 via graphical elements rendered on a display element (e.g., the display device 216). Accordingly, the user interface 206 may initiate the creation, maintenance, and presentation of a graphical user interface (GUI). In certain embodiments, the display device 216 implements touch-sensitive technology for purposes of interacting with the GUI. Thus, a user can manipulate the GUI by moving a cursor symbol rendered on the display device 216, or by physically interacting with the display device 216 itself for recognition and interpretation, via the user interface 206.

The global designs module 208 is configured to access stored global automotive design data that has been created and stored for reconfiguration and future use in the electrical architecture design of a vehicle platform. Global design data is a listing or registry of the available features, characteristics, and automotive options for a set of vehicles, including a particular manufactured brand of vehicle, a particular make of vehicle, a particular model of vehicle, a particular design of vehicle, and/or any applicable set or group of vehicles.

Automotive options are features, variations, and other details specific to a set of vehicles. For example, automotive options for a vehicle may include side marker lamps or a lack of side marker lamps, wherein the side marker lamps is an automotive option and the lack of side marker lamps is an automotive option. Further, automotive options may include sub-options. For example, the automotive option for side marker lamps may include either incandescent side marker lamps or light emitting diode (LED) side marker lamps, wherein the incandescent side marker lamps are another automotive option and the LED side marker lamps are another automotive option. The global designs module 208 may access global automotive design data stored locally in system memory 204 or remotely stored global automotive design data via a wired or wireless communication connection to one or more servers (see reference 104, FIG. 1).

The vehicle platform module 210 is configured to access stored data associated with a particular vehicle platform. A vehicle platform is a subset of the global design data, wherein the vehicle platform includes automotive options, and variations of automotive options, that are specific to a particular vehicle make and/or vehicle model. In some embodiments, the platform-specific automotive options are a subset of the global automotive options. In this case, not all global design automotive options are included in a particular vehicle platform. Thus, some of the global design automotive options are unused in the particular vehicle platform, and this is indicated in the vehicle platform data. In some embodiments, some of the global design automotive options are used in every implementation of a particular vehicle platform. In this case, such global design automotive options are referred to as “standard” options for the vehicle platform, and this is indicated in the vehicle platform data. In some embodiments, a global design automotive option may only be available to the vehicle platform in a certain form or variation. The platform-specific variation or characteristic may be indicated by a code in the vehicle platform data.

The mapping module 212 is configured to create a mapping or translation file that associates global design data to a vehicle specific platform. The mapping module 212 translates the automotive options of the global design data into terms applicable to a vehicle platform, to create a mapping file. The mapping module 212 identifies the availability of particular options for a particular vehicle platform, and translates or “maps” the global automotive options into these vehicle platform-specific terms, wherein the vehicle platform-specific terms constrain the global automotive options such that the global automotive options are applicable to the particular vehicle platform. The mapping module 212 stores this translation (i.e., mapping) in a mapping file. Exemplary embodiments of the mapping file include a look-up table that includes global design automotive options and platform-specific automotive options or option expressions for each global design automotive option, thus allowing the ability to map a single term to a single term or single term to a multi-term expression.

The electrical architecture reconfiguration module 214 is configured to use the mapping file, generated by the mapping module 212, to create electrical build configurations for vehicle subsystems of the vehicle platform, and to generate wiring diagrams for the electrical build configurations. The electrical architecture reconfiguration module 214 obtains a design project applicable to the vehicle platform. A design project is a software model of a vehicle platform, which may be used by a developer to design variations of the particular vehicle platform. The design project includes mathematical and/or logical expressions associated with the automotive options and a vehicle platform diagram. The electrical architecture reconfiguration module 214 generates a mapped set of designs for the design project, using the terms applicable to the vehicle platform. The mapped set of designs includes a revised design project, wherein the design project has been edited to incorporate the translated or mapped automotive options stored in the mapping file. Thus, the mapped set of designs includes vehicle platform-specific automotive options, and may be used in applications specific to the particular vehicle platform. The electrical architecture reconfiguration module 214 also creates electrical build configurations for the vehicle platform, based on the mapped set of designs. An electrical build configuration is a logical or mathematical design associated with the completed vehicle platform, and includes design expressions that are specific to the vehicle platform.

In practice, the global designs module 208, the vehicle platform module 210, the mapping module 212, and/or the electrical architecture reconfiguration module 214 may be implemented with (or cooperate with) the at least one processor 202 to perform at least some of the functions and operations described in more detail herein. In this regard, the global designs module 208, the vehicle platform module 210, the mapping module 212, and/or the electrical architecture reconfiguration module 214 may be realized as suitably written processing logic, application program code, or the like.

The display device 216 is configured to display various icons, text, and/or graphical elements associated with global design data, vehicle platform data, mapping data, electrical build configuration data, or the like. In an exemplary embodiment, the display device 216 and the user interface 206 are communicatively coupled to the at least one processor 202. The at least one processor 202, the user interface 206, and the display device 216 are cooperatively configured to display, render, or otherwise convey one or more graphical representations or images associated with automotive software design and electrical build configurations on the display device 216, as described in greater detail below. In an exemplary embodiment, the display device 216 is realized as an electronic display configured to graphically display electrical build configuration data, as described herein. In some embodiments, the display device 216 is implemented as a display screen of a standalone, personal computing device (e.g., laptop computer, tablet computer). It will be appreciated that although the display device 216 may be implemented using a single display, certain embodiments may use additional displays (i.e., a plurality of displays) to accomplish the functionality of the display device 216 described herein.

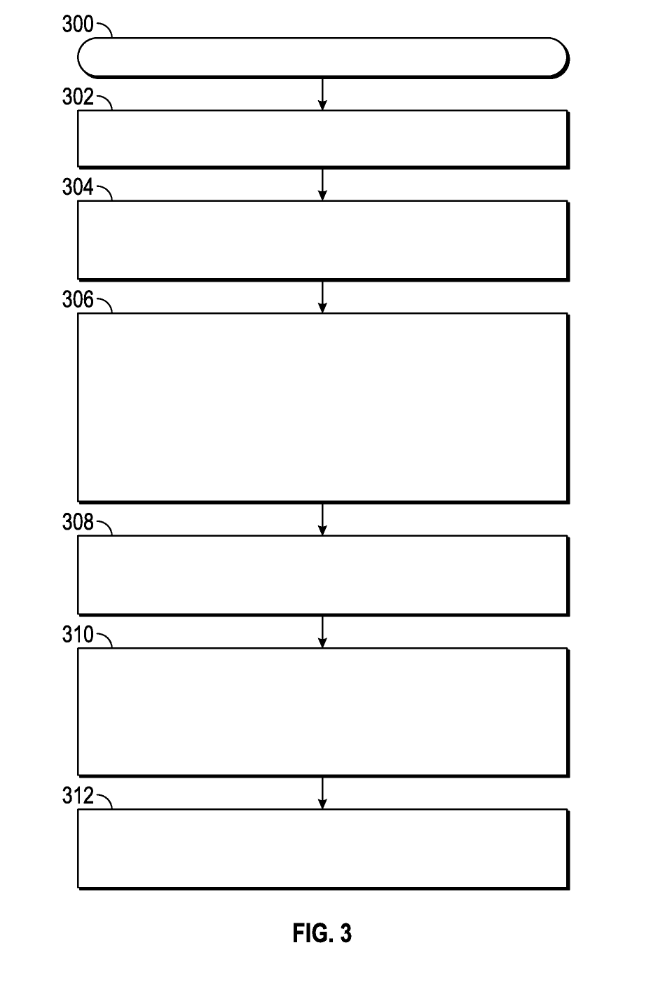

FIG. 3 is a flow chart that illustrates an embodiment of a process 300 for reconfiguring an electrical architecture for a vehicle, in accordance with the disclosed embodiments. First, the process 300 obtains global design data comprising automotive options applicable to a set of vehicles, by a processor (step 302). Global design data may include all available automotive options for a particular manufactured brand of vehicle, a particular make of vehicle, a particular model of vehicle, a particular design of vehicle, and/or any applicable set or group of vehicles. Automotive options are features, variations, and other details specific to a set of vehicles. For example, automotive options for a vehicle may include side marker lamps or a lack of side marker lamps, wherein the side marker lamps is an automotive option and the lack of side marker lamps is an automotive option. Further, automotive options may include sub-options. For example, the automotive option for side marker lamps may include either incandescent side marker lamps or light emitting diode (LED) side marker lamps, wherein the incandescent side marker lamps are one automotive option and LED side marker lamps are another automotive option.

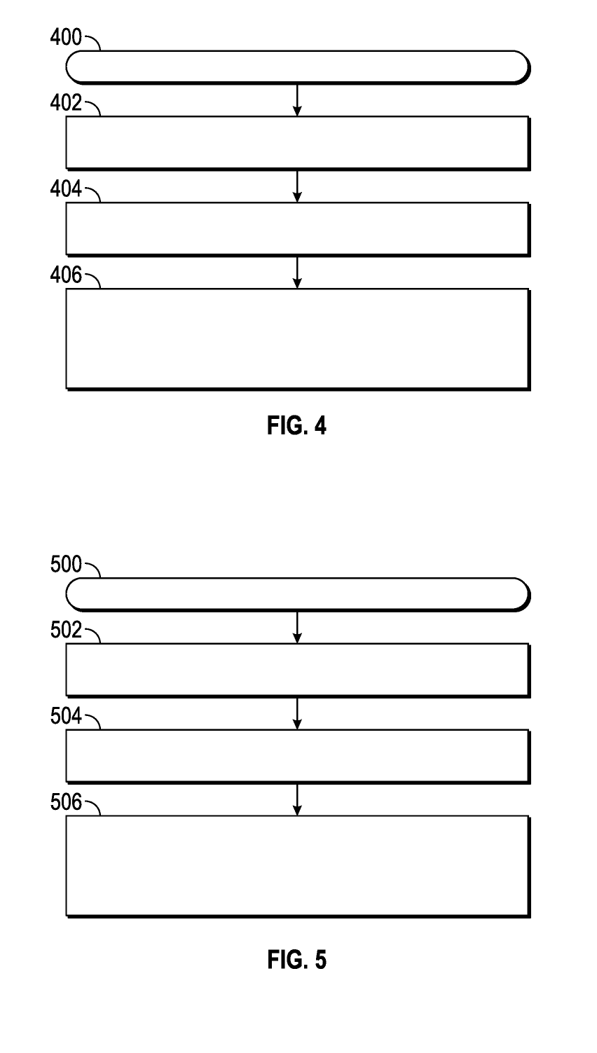

Next, the process 300 translates the automotive options of the global design data into terms applicable to a vehicle platform, to create a mapping file (step 304). Suitable methodologies for translating the automotive options of the global design data into terms applicable to a vehicle platform, to create a mapping file, are described below with reference to FIGS. 4-6. A vehicle platform is a subset of the global design data, wherein the vehicle platform includes automotive options, and variations of automotive options, that are specific to a particular vehicle make and/or vehicle model. The automotive options of the global design data may include a broader range of options than the options available to the particular vehicle platform, and more variations for each particular global design automotive option than the option variations available to the particular vehicle platform. Here, the process 300 identifies whether a global design automotive option is a standard option for the vehicle platform, an unused option of the vehicle platform, and whether each of the global design automotive options is associated with a particular variation (or variations) of that option available to the vehicle platform. Essentially, the process 300 identifies the availability of particular options for a particular vehicle platform, and translates (i.e., “maps”) the global automotive options into these vehicle platform-specific terms, wherein the vehicle platform-specific terms constrain the global automotive options such that the global automotive options are applicable to the particular vehicle platform. The process 300 stores this translation (i.e., mapping) in a mapping file. Exemplary embodiments of the mapping file include a look-up table that includes global design automotive options and one or more associated platform-specific automotive options for each global design automotive option.

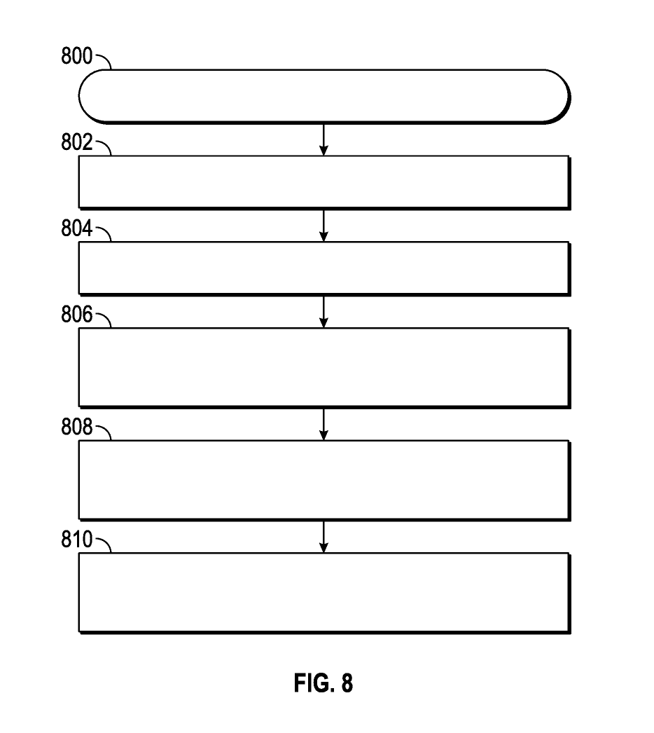

In some embodiments, the process 300 includes the creation of a mapping file primer to assist the architect in the manual step of providing the actual mappings from global to platform options (described below with regard to FIG. 8). The primer is built based on the user-selected set of designs (e.g., current, build list, latest revision) and includes all options present in those designs that have not already been specified as platform options (e.g., options that have already been mapped and may be used for repeated mappings).

The process 300 then obtains a design project applicable to the vehicle platform, wherein the design project comprises at least a plurality of expressions associated with the automotive options and a vehicle platform diagram, and wherein the plurality of expressions comprise at least one of mathematical expressions and logical expressions (step 306). A design project is a software model of a vehicle platform, which may be used by a developer to design variations of the particular vehicle platform. The design project includes mathematical and/or logical expressions associated with the automotive options and a vehicle platform diagram.

The process 300 generates a mapped set of designs for the design project, using the terms applicable to the vehicle platform (step 308). One suitable methodology for generating a mapped set of designs for the design project is described below with reference to FIG. 7. The mapped set of designs includes a revised design project, wherein the design project has been edited to incorporate the translated or mapped automotive options stored in the mapping file. Thus, the mapped set of designs includes vehicle platform-specific automotive options, and may be used in applications specific to the particular vehicle platform.

The process 300 then creates electrical build configurations for the vehicle platform, based on the mapped set of designs, wherein the electrical build configurations comprise a revised vehicle platform design (step 310). An electrical build configuration is a logical or mathematical design associated with the completed vehicle platform, and includes design expressions that are specific to the vehicle platform. Thus, the process 300 narrows the global set of automotive options into a vehicle platform-specific set of automotive options available to a particular vehicle platform via mapping, provides the mapping to the electrical architecture design environment, and designs the electrical build configurations based on the narrowed set of available automotive options.

FIG. 4 is a flow chart that illustrates an embodiment of a process 400 for translating the automotive options, in accordance with the disclosed embodiments. It should be appreciated that the process 400 described in FIG. 4 represents one embodiment of step 304 described above in the discussion of FIG. 3, including additional detail. First, the process 400 identifies a group of automotive options associated with the vehicle platform (step 402).

Each vehicle platform may include a plurality of automotive options. For example, vehicle Model X may include Options A, B, and C. Vehicle Model Y may include Options D, E, and F. A global design option within exterior lighting could be side marker lamps, where side marker lamps can be incandescent or light emitting diode (LED). Examples of abbreviated terms that signify these options may include, without limitation, SI_MRK_LPS_INC and SI_MRK_LPS_LED. When a vehicle platform does not include side marker lamps, SI_MRK_LPS_INC and SI_MRK_LPS_LED may be mapped to “UNUSED”. When a vehicle platform always includes side marker lamps, the appropriate type may be mapped to “STANDARD” and the other type may be mapped to “UNUSED” (SI_MRK_LPS_INC=STANDARD with SI_MRK_LPS_LED=UNUSED, or vice versa). When a vehicle platform has optional conditions that include one or more types of side marker lamps, they would define the criteria under which the vehicle platform includes side marker lamps may be defined using a Regular Production Option (RPO) (e.g., an alpha/numeric designation assigned to a vehicle feature) or option expression comprised of multiple RPOs. For example, if the Chevrolet Camaro never has Side Marker Lamps, then SI_MRK_LPS_INC=UNUSED and SI_MRK_LPS_LED=UNUSED and if the Chevrolet Colorado has incandescent side marker lamps only when selected as a customer feature, then SI_MRK_LPS=62H. When a mid-size truck platform does not include side marker lamps for a Chevrolet Colorado, but does include side marker lamps for a GMC Canyon, then SI_MRK_LPS=62H&Z88 where 62H represents side marker lamps and Z88 represents GMC.

Next, the process 400 determines platform-specific characteristics associated with each of the group (step 404). Here, the process 400 identifies characteristics and/or variations available to the vehicle platform. The process 400 then maps each of the group to a code associated with one of the platform-specific characteristics, wherein the terms applicable to the vehicle platform comprise the platform-specific characteristics (step 406), thus permitting each global design option to map to a vehicle-specific option or vehicle-specific multi-term expression. The process 400 includes the code in the mapping file, such that the code is associated with a global design automotive option that is standard to the vehicle platform in use. As described with regard to FIG. 3, exemplary embodiments of the mapping file include a look-up table that includes global design automotive options and one or more associated platform-specific automotive options for each global design automotive option. Here, the process 400 may include the code in the look-up table, and thus, the global design automotive option is identified as a platform-specific automotive option that includes the platform-specific characteristics, in the look-up table. The look-up table is used in later applications to create electrical build configurations and wiring diagrams for the vehicle platform.

FIG. 5 is a flow chart that illustrates a second embodiment of a process 500 for translating the automotive options, in accordance with the disclosed embodiments. It should be appreciated that the process 500 described in FIG. 5 represents one embodiment of step 304 described above in the discussion of FIG. 3, including additional detail. The process 500 identifies a group of automotive options associated with the vehicle platform (step 502). The process 500 then determines that each of the group is a standard option associated with the vehicle platform (step 504). Standard options are a subset of the automotive vehicle options, wherein the subset is generally included in implementations of the vehicle platform.

Next, the process 500 maps each of the group to a code indicating the standard option, wherein the terms applicable to the vehicle platform comprise the code (step 506). The process 500 includes the code in the mapping file, such that the code is associated with a global design automotive option that is standard to the vehicle platform in use. Options mapped to “standard” are treated as though standard options always exist for the vehicle platform, including vehicle content with respect to wiring, components, and designs. For example, a component with a global expression of “A B”, where A is mapped to STANDARD for a specific platform, is always present in the vehicle as “A”. Thus, the global expression is not treated as TRUE.

As described with regard to FIG. 3, exemplary embodiments of the mapping file include a look-up table that includes global design automotive options and one or more associated platform-specific automotive options for each global design automotive option. Here, the process 500 may include the code in the look-up table, and thus, the global design automotive option is identified as a standard, platform-specific automotive option in the look-up table. The look-up table is used in later applications to create electrical build configurations and wiring diagrams for the vehicle platform.

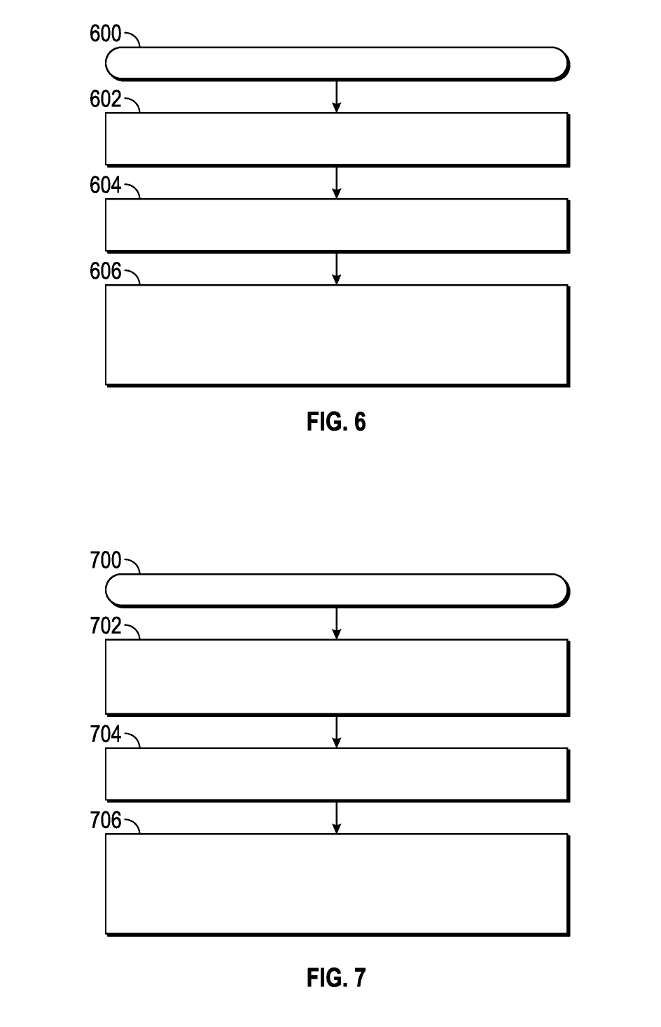

FIG. 6 is a flow chart that illustrates a third embodiment of a process 600 for translating the automotive options, in accordance with the disclosed embodiments. It should be appreciated that the process 600 described in FIG. 6 represents one embodiment of step 304 described above in the discussion of FIG. 3, including additional detail. First, the process 600 identifies a group of automotive options associated with the vehicle platform (step 602). The process 600 then determines that each of the group is an unused option associated with the vehicle platform (step 604). Unused options are a subset of the automotive vehicle options, wherein the subset is not included in implementations of the vehicle platform.

Next, the process 600 maps each of the group to a code indicating the unused option, wherein the terms applicable to the vehicle platform comprise the code (step 606). The process 600 includes the code in the mapping file, such that the code is associated with a global design automotive option that is unused in the vehicle platform in use. As described with regard to FIG. 3, exemplary embodiments of the mapping file include a look-up table that includes global design automotive options and one or more associated platform-specific automotive options for each global design automotive option. Here, the process 600 may include the code in the look-up table, and thus, the global design automotive option is identified as an unused, platform-specific automotive option in the look-up table. In certain embodiments, such unused options are deleted from the look-up table, instead of including a code indicating that the automotive option is unused in the particular vehicle platform. The look-up table is used in later applications to create electrical build configurations and wiring diagrams for the vehicle platform. As one exemplary embodiment, when a component is associated with a global expression “A && B” and B is mapped to UNUSED, the content defined by the expression can never be present in the vehicle, regardless of the inclusion of option A.

FIG. 7 is a flow chart that illustrates an embodiment of a process 700 for generating a mapped set of designs, in accordance with the disclosed embodiments. It should be appreciated that the process 700 described in FIG. 7 represents one embodiment of step 308 described above in the discussion of FIG. 3, including additional detail. First, the process 700 identifies a subset of the plurality of expressions of the design project, wherein the subset includes one of the automotive options (step 702). The subset of the plurality of expressions may include a particular global design automotive option, or a variation of a particular global design automotive option, in addition to other terms and options applicable to the expression. In other words, each expression may include one or more variables, wherein a variable is representative of an automotive option or variation of an automotive option. Each of the global design automotive options is included in the design project as a mathematical or logical expression, or part of a mathematical or logical expression. Here, the process 700 selects a group of global expressions for translation to a particular vehicle platform.

Next, the process 700 finds instances of the one of the automotive options in the subset (step 704). Each of the subset of the plurality of expressions may include a plurality of variables. Each expression and/or each variable represents an instance of an automotive option. Here, the process 700 locates instances of one particular automotive option, in the subset of the plurality of expressions.

The process 700 then replaces the instances of the one of the automotive options with one of the terms applicable to the vehicle platform (step 706). The instances may include expressions and/or variables representative of a particular global design automotive option. Here, the process 700 replaces the particular global design automotive option with a different option that is available to the vehicle platform, thereby specifying the automotive option design for the particular vehicle platform. Thus, the process 700 performs an advanced, high-level, find-and-replace operation within the design project, such that the design project is revised to generate a revised design project. Such a revised design project may be used to create electrical build configurations and wiring diagrams for a particular vehicle platform.

FIG. 8 is a flow chart that illustrates an embodiment of a process 800 for initiating reconfiguration of an electrical architecture for a vehicle, in accordance with the disclosed embodiments. First, the process 800 presents a graphical user interface (GUI), by a display device communicatively coupled to the processor (step 802), wherein the GUI presents potential user input selections associated with user-identified design details.

Next, the process 800 receives a first user input selection of the mapping file, via the GUI (step 804). Here, the process 800 receives the mapping data for use in translating a global automotive design into a vehicle platform-specific design. A vehicle platform is a subset of the global design data, wherein the vehicle platform includes automotive options, and variations of automotive options, that are specific to a particular vehicle make and/or vehicle model. Each mapping file may be associated with a different vehicle platform. A vehicle platform can be defined as a vehicle make and model or a set of vehicle makes and models. For example, a vehicle platform could be a rear wheel drive sports vehicle which includes such vehicles as a Chevrolet Camaro, or mid-size trucks which includes a Chevrolet Colorado and a GMC Canyon.

The process 800 then receives a second user input selection of one of a build list, a current design, and a latest revision, via the GUI (step 806). The process 800 generates a primer option report, in response to the first user input selection and the second user input selection (step 808). The process 800 then creates the electrical build configurations for the second user input selection and based on the primer option report (step 810). Here, the user can create a mapping “primer” file through the GUI, and can select the primer file to use during the mapping process. The user also selects the scope of the mapping by defining the set of designs as either just the currently open design, a defined list of designs called a “build list”, or the latest revision of every design from the currently opened project.

The various tasks performed in connection with processes 300-800 may be performed by software, hardware, firmware, or any combination thereof. For illustrative purposes, the preceding descriptions of processes 300-800 may refer to elements mentioned above in connection with FIGS. 1-2. In practice, portions of processes 300-800 may be performed by different elements of the described system. It should be appreciated that processes 300-800 may include any number of additional or alternative tasks, the tasks shown in FIGS. 3-8 need not be performed in the illustrated order, and processes 300-800 may be incorporated into a more comprehensive procedure or process having additional functionality not described in detail herein. Moreover, one or more of the tasks shown in FIGS. 3-8 could be omitted from embodiments of processes 300-800 as long as the intended overall functionality remains intact.

Techniques and technologies may be described herein in terms of functional and/or logical block components, and with reference to symbolic representations of operations, processing tasks, and functions that may be performed by various computing components or devices. Such operations, tasks, and functions are sometimes referred to as being computer-executed, computerized, software-implemented, or computer-implemented. In practice, one or more processor devices can carry out the described operations, tasks, and functions by manipulating electrical signals representing data bits at memory locations in the system memory, as well as other processing of signals. The memory locations where data bits are maintained are physical locations that have particular electrical, magnetic, optical, or organic properties corresponding to the data bits. It should be appreciated that the various block components shown in the figures may be realized by any number of hardware, software, and/or firmware components configured to perform the specified functions. For example, an embodiment of a system or a component may employ various integrated circuit components, e.g., memory elements, digital signal processing elements, logic elements, look-up tables, or the like, which may carry out a variety of functions under the control of one or more microprocessors or other control devices.

When implemented in software or firmware, various elements of the systems described herein are essentially the code segments or instructions that perform the various tasks. The program or code segments can be stored in a processor-readable medium or transmitted by a computer data signal embodied in a carrier wave over a transmission medium or communication path. The “computer-readable medium”, “processor-readable medium”, or “machine-readable medium” may include any medium that can store or transfer information. Examples of the processor-readable medium include an electronic circuit, a semiconductor memory device, a ROM, a flash memory, an erasable ROM (EROM), a floppy diskette, a CD-ROM, an optical disk, a hard disk, a fiber optic medium, a radio frequency (RF) link, or the like. The computer data signal may include any signal that can propagate over a transmission medium such as electronic network channels, optical fibers, air, electromagnetic paths, or RF links. The code segments may be downloaded via computer networks such as the Internet, an intranet, a LAN, or the like.

The following description refers to elements or nodes or features being “connected” or “coupled” together. As used herein, unless expressly stated otherwise, “coupled” means that one element/node/feature is directly or indirectly joined to (or directly or indirectly communicates with) another element/node/feature, and not necessarily mechanically. Likewise, unless expressly stated otherwise, “connected” means that one element/node/feature is directly joined to (or directly communicates with) another element/node/feature, and not necessarily mechanically. Thus, although the schematic shown in FIG. 2 depicts one exemplary arrangement of elements, additional intervening elements, devices, features, or components may be present in an embodiment of the depicted subject matter.

For the sake of brevity, conventional techniques related to signal processing, data transmission, signaling, network control, and other functional aspects of the systems (and the individual operating components of the systems) may not be described in detail herein. Furthermore, the connecting lines shown in the various figures contained herein are intended to represent exemplary functional relationships and/or physical couplings between the various elements. It should be noted that many alternative or additional functional relationships or physical connections may be present in an embodiment of the subject matter.

Some of the functional units described in this specification have been referred to as “modules” in order to more particularly emphasize their implementation independence. For example, functionality referred to herein as a module may be implemented wholly, or partially, as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices, or the like. Modules may also be implemented in software for execution by various types of processors. An identified module of executable code may, for instance, comprise one or more physical or logical modules of computer instructions that may, for instance, be organized as an object, procedure, or function. Nevertheless, the executables of an identified module need not be physically located together, but may comprise disparate instructions stored in different locations that, when joined logically together, comprise the module and achieve the stated purpose for the module. Indeed, a module of executable code may be a single instruction, or many instructions, and may even be distributed over several different code segments, among different programs, and across several memory devices. Similarly, operational data may be embodied in any suitable form and organized within any suitable type of data structure. The operational data may be collected as a single data set, or may be distributed over different locations including over different storage devices, and may exist, at least partially, merely as electronic signals on a system or network.

While at least one exemplary embodiment has been presented in the foregoing detailed description, it should be appreciated that a vast number of variations exist. It should also be appreciated that the exemplary embodiment or embodiments described herein are not intended to limit the scope, applicability, or configuration of the claimed subject matter in any way. Rather, the foregoing detailed description will provide those skilled in the art with a convenient road map for implementing the described embodiment or embodiments. It should be understood that various changes can be made in the function and arrangement of elements without departing from the scope defined by the claims, which includes known equivalents and foreseeable equivalents at the time of filing this patent application.

What is claimed is:

1. A method for reconfiguring an electrical architecture for a vehicle, the method comprising:
obtaining global design data comprising automotive options applicable to a set of vehicles, by a processor, wherein the set of vehicles comprises the vehicle;
translating the automotive options of the global design data into terms applicable to a vehicle platform, to create a mapping file;
obtaining a design project applicable to the vehicle platform, wherein the design project comprises at least a plurality of expressions associated with the automotive options and a vehicle platform diagram, and wherein the plurality of expressions comprise at least one of mathematical expressions and logical expressions;
generating an mapped set of designs for the design project, using the terms applicable to the vehicle platform; and
creating electrical build configurations for the vehicle platform, based on the mapped set of designs, wherein the electrical build configurations comprise a revised vehicle platform design.

2. The method of claim 1, wherein translating the automotive options further comprises:
identifying a group of the automotive options associated with the vehicle platform;
determining platform-specific characteristics associated with each of the group; and
mapping each of the group to a code associated with one of the platform-specific characteristics, wherein the terms applicable to the vehicle platform comprise the platform-specific characteristics.

3. The method of claim 1, wherein translating the automotive options further comprises:
identifying a group of the automotive options associated with the vehicle platform;
determining that each of the group is a standard option associated with the vehicle platform; and
mapping each of the group to a code indicating the standard option, wherein the terms applicable to the vehicle platform comprise the code.

4. The method of claim 1, wherein translating the automotive options further comprises:
identifying a group of the automotive options not associated with the vehicle platform;
determining that each of the group is an unused option of the vehicle platform; and
mapping each of the group to a code indicating the unused option, wherein the terms applicable to the vehicle platform comprise the code.

5. The method of claim 1, wherein generating a mapped set of designs for the design project further comprises:
identifying a subset of the plurality of expressions of the design project, wherein the subset includes one of the automotive options;
finding instances of the one of the automotive options in the subset; and
replacing the instances of the one of the automotive options with one of the terms applicable to the vehicle platform.

6. The method of claim 1, further comprising:
identifying vehicle subsystems associated with the vehicle platform and the mapped set of designs;
creating the electrical build configurations for the vehicle subsystems, based on the mapped set of designs; and
generating an electrical wiring architecture for the vehicle platform, based on the electrical build configurations.

7. The method of claim 1, further comprising:
presenting a graphical user interface (GUI), by a display device communicatively coupled to the processor;
receiving a user input selection of the mapping file, via the GUI; and
generating the mapped set of designs, in response to the user input selection.

8. The method of claim 1, further comprising:
presenting a graphical user interface (GUI), by a display device communicatively coupled to the processor;
receiving a user input selection of one of a build list, a current design, and a latest revision, via the GUI; and
generating a primer option report for the user input selection; and
creating the electrical build configurations for the user input selection.

9. A system for reconfiguring an electrical architecture for a vehicle, the system comprising:
a memory element, configured to store vehicle platform data and global design data comprising automotive options applicable to a set of vehicles; and
at least one processor, communicatively coupled to the memory element, wherein the at least one processor is configured to:
obtain global design data comprising automotive options applicable to the set of vehicles, wherein the set of vehicles comprises the vehicle;
translate the automotive options of the global design data into terms applicable to a vehicle platform, to create a mapping file;
obtain a design project applicable to the vehicle platform, wherein the design project comprises at least a plurality of expressions associated with the automotive options and a vehicle platform diagram, and wherein the plurality of expressions comprise at least one of mathematical expressions and logical expressions;
generate a mapped set of designs for the design project, using the terms applicable to the vehicle platform; and
create electrical build configurations for the vehicle platform, based on the mapped set of designs, wherein the electrical build configurations comprise a revised vehicle platform design.

10. The system of claim 9, wherein the at least one processor is configured to translate the automotive options by:
identifying a group of the automotive options associated with the vehicle platform;
determining platform-specific characteristics associated with each of the group; and
mapping each of the group to a code associated with one of the platform-specific characteristics, wherein the terms applicable to the vehicle platform comprise the platform-specific characteristics.

11. The system of claim 9, wherein the at least one processor is configured to translate the automotive options by:
identifying a group of the automotive options associated with the vehicle platform;
determining that each of the group is a standard option associated with the vehicle platform; and
mapping each of the group to a code indicating the standard option, wherein the terms applicable to the vehicle platform comprise the code.

12. The system of claim 9, wherein the at least one processor is configured to translate the automotive options by:
identifying a group of the automotive options not associated with the vehicle platform;
determining that each of the group is an unused option of the vehicle platform; and
mapping each of the group to a code indicating the unused option, wherein the terms applicable to the vehicle platform comprise the code.

13. The system of claim 9, wherein the at least one processor is configured to generate a mapped set of designs for the design project by:
identifying a subset of the plurality of expressions of the design project, wherein the subset includes one of the automotive options;
finding instances of the one of the automotive options in the subset; and
replacing the instances of the one of the automotive options with one of the terms applicable to the vehicle platform.

14. The system of claim 9, wherein the at least one processor is further configured to:
identify vehicle subsystems associated with the vehicle platform and the mapped set of designs;
create the electrical build configurations for the vehicle subsystems, based on the mapped set of designs; and
generate an electrical wiring architecture for the vehicle platform, based on the electrical build configurations.

15. The system of claim 9, further comprising a display device communicatively coupled to the at least one processor, wherein the display device is configured to present a graphical user interface (GUI);
wherein the at least one processor is further configured to:
receive a user input selection of the mapping file, via the GUI; and
generate the mapped set of designs, in response to the user input selection.

16. The system of claim 9, further comprising a display device communicatively coupled to the at least one processor, wherein the display device is configured to present a graphical user interface (GUI);
wherein the at least one processor is further configured to:
receive a user input selection of one of a build list, a current design, and a latest revision, via the GUI; and
generate a primer option report for the user input selection; and
create the electrical build configurations for the user input selection, based on the primer option report and the mapped set of designs.

17. A non-transitory, computer-readable medium containing instructions thereon, which, when executed by a processor, perform a method comprising:
obtaining global design data comprising automotive options applicable to a set of vehicles, by the processor;
translating the automotive options of the global design data into terms applicable to a vehicle platform, to create a mapping file;
obtaining a design project applicable to the vehicle platform, wherein the design project comprises at least a plurality of expressions associated with the automotive options and a vehicle platform diagram, and wherein the plurality of expressions comprise at least one of mathematical expressions and logical expressions;
generating a mapped set of designs for the design project, using the terms applicable to the particular vehicle platform, by:
identifying a subset of the plurality of expressions of the design project, wherein the subset includes one of the automotive options;
finding instances of the one of the automotive options in the subset; and
replacing the instances of the one of the automotive options with one of the terms applicable to the vehicle platform;
creating electrical build configurations for the vehicle platform, based on the mapped set of designs, wherein the electrical build configurations comprise a revised vehicle platform design; and
generating an electrical wiring architecture for the vehicle platform, based on the electrical build configurations.

18. The non-transitory, computer-readable medium of claim 17, wherein translating the automotive options further comprises:
identifying a group of the automotive options associated with the vehicle platform;
determining platform-specific characteristics associated with each of the group; and
mapping each of the group to a code associated with one of the platform-specific characteristics, wherein the terms applicable to the vehicle platform comprise the platform-specific characteristics.

19. The non-transitory, computer-readable medium of claim 17, wherein translating the automotive options further comprises:
identifying a group of the automotive options associated with the vehicle platform;
determining that each of the group is a standard option associated with the vehicle platform; and
mapping each of the group to a code indicating the standard option, wherein the terms applicable to the vehicle platform comprise the code.

20. The non-transitory, computer-readable medium of claim 17, wherein translating the automotive options further comprises:
identifying a group of the automotive options not associated with the vehicle platform;
determining that each of the group is an unused option of the vehicle platform; and
mapping each of the group to a code indicating the unused option, wherein the terms applicable to the vehicle platform comprise the code.
